(19) United States
(12) Patent Application Publication
(10) Pub. No.: US 2022/0001856 A1
(43) Pub. Date: Jan. 6, 2022

(54) METHOD FOR SECURING A STARTING MOVEMENT OF A SEMI-AUTOMATED OR FULLY AUTOMATED VEHICLE

(71) Applicant: Robert Bosch GmbH, Stuttgart (DE)

(72) Inventor: Roland Schmid, Herrenberg (DE)

(21) Appl. No.: 17/358,317

(22) Filed: Jun. 25, 2021

(30) Foreign Application Priority Data
Jul. 2, 2020 (DE) 102020208308.8

(51) Int. Cl. B60W 30/06; G06K 9/00; G06T 7/246; G06K 9/62; H04N 5/232; B60W 60/00; B60W 40/04; B60W 40/06

(52) U.S. Cl. CPC B60W 30/06; G06K 9/00805; G06T 7/248; G06K 9/627; H04N 5/23299; B60W 2554/80; B60W 40/04; B60W 40/06; G06T 2207/30264; B60W 2420/54; B60W 2420/52; B60W 60/0015

(57) ABSTRACT

A method for securing a starting movement of a semi-automated or fully automated vehicle, the vehicle including at least one imaging sensor, which is configured to capture images of a close-up range of the vehicle. A recognition of objects in the close-up range of the vehicle is carried out. A starting movement of the vehicle is prevented if an object has been recognized.

### CROSS REFERENCE

The present application claims the benefit under 35 U.S.C. § 119 of German Patent Application No. DE 102020208308.8 filed on Jul. 2, 2020, which is expressly incorporated herein by reference in its entirety.

### FIELD

The present invention relates to a method for securing a starting movement of a semi-automated or fully automated vehicle. The vehicle may, for example, be a so-called AVP vehicle, which is configured to move fully automatically within a parking surroundings within the scope of an automated valet parking (AVP) system, the parking surroundings being able to include a central unit and a plurality of stationary sensor units, and the parking surroundings or the AVP vehicle itself capable of being configured to guide the vehicle to a target position in the parking surroundings. Further aspects of the present invention relate to a device, which is configured to carry out a corresponding method, as well as a vehicle including such a device drivable in a semi-automated or fully automated manner. The present invention further relates to a computer program.

### BACKGROUND INFORMATION

Modern vehicles are equipped with driver assistance systems in order to assist the driver of a vehicle when carrying out various driving maneuvers. In this case, fully automated and semi-automated systems are conventional. In fully automated systems, the driving maneuver to be carried out is automatically carried out by the driver assistance system, both with respect to the longitudinal guidance and with respect to the transverse guidance of the vehicle without a driver intervening in or monitoring the driving maneuver. In this case, longitudinal guidance is understood to mean the acceleration or deceleration of the vehicle and transverse guidance is understood to mean the steering of the vehicle. In a semi-automated system, the driver monitors the driving maneuver executed fully automatically by the system or the driver of the vehicle either carries out the longitudinal guidance and the transverse guidance is taken over by the driver assistance system, or the transverse guidance is carried out by the driver of the vehicle and the longitudinal guidance is taken over by the driver assistance system.

Conventional methods include methods for assigning a vehicle a target position in a parking surroundings, for guiding the vehicle in an automated manner to the target position without the intervention of a driver, and for parking the vehicle at the target position. Such systems are known as automated valet parking (AVP) methods.

PCT Patent Application No. WO 2019/028464 A1 describes a method for the automatic control of an activation and deactivation of an autonomous operation of vehicles.

Vehicles driving in an automated or autonomous manner which, in particular, no longer have a driver in the vehicle, must begin to move again after pauses, charging processes, loading processes, stopping processes, etc., and require the certainty that no one is located directly next to the vehicle, in the so-called close-up range of the vehicle. For example, a child could be located next to the vehicle. Objects could also be standing in the close-up range next to the vehicle, which could be damaged when driving off, or which could damage the vehicle.

Vehicles driving in an automated or autonomous manner, which are operated based on an onboard sensor system, must generally recognize, interpret the vehicle surroundings and carry out the driving maneuver in such a way that no collisions occur, either with vehicles, stationary obstacles, or with persons. In such vehicles, obstacles in the closer surroundings are detected, for example, with ultrasonic sensors, close-up range cameras and, in part, also with LIDAR sensors and/or radar sensors. Because of the limited number of installed sensors, detection gaps remain, in particular, in the close-up range of the vehicle between the individual sensors.

The conventional detection algorithms in vehicle-mounted cameras, usually mono-cameras, are based, for example, on the following methods:

One first conventional detection method in digital image processing is the object classification on the basis of the object shape. With this method, it is possible, for example, to detect vehicles, motorcyclists, bicyclists or pedestrians. The tracking of the object across multiple images is frequently required for reliable detection.

One second conventional detection method is the stereoscopic measurement of objects according to the “Structure from Motion (SfM)” principle. In this method, at least two images recorded successively when the vehicle is in motion are evaluated. As a result of the vehicle motion, objects in the first and second image are viewed from different perspectives, from which object sizes and distances to the camera are able to be ascertained.

It is further conventional to monitor the vehicle and the spatial areas around the vehicle using cameras, in particular, mono-cameras situated stationarily in an infrastructure. In the case of such stationary cameras, i.e., not vehicle-mounted mono-cameras, it is possible to detect objects using two different methods. The first method is the object classification according to the above-described first method. The second method is the recognition of moving objects by evaluating image differences in images that have been recorded at different points in time. However, no “Structure from Motion” analysis is possible using stationary cameras, since the stationary camera generally does not move. Furthermore, stationary cameras are not provided everywhere and non-viewable areas, in particular, in a close-up range of the parked vehicle, may result due to the mounting location of the stationary cameras.

When beginning to move again in an automatic, driverless fashion, the areas of the front of the vehicle and of the rear of the vehicle in particular, but also the sides of the vehicle, represent particularly critical areas, since, even on the side of the vehicle, it is possible, for example, that persons are pulled along and run over when beginning to move again, in particular, small children located in these critical areas. Close-up range cameras, also referred to as near-field cameras, which are normally installed in the vehicle front, in the rear and/or in the side mirrors, may possibly not be able to detect such objects as such when the vehicle is at a standstill. This is particularly the case if only parts of the object are able to be detected by the camera due to the proximity of the object to the vehicle, and a shape-based object classification using digital image processing is therefore not possible.

### SUMMARY

An object of the present invention may be to secure a starting movement of a semi-automated or fully automated or highly automated and, in particular, driverless vehicle in such a way that collisions of the vehicle with persons or objects, which have entered into a spatial area very close to the vehicle, the so-called close-up range of the vehicle, in the interim between the parking and the starting movement of the vehicle, are prevented.

This object may be achieved with the aid of an example embodiment of the present invention. Advantageous example embodiments of the present invention are disclosed herein.

Autonomously driving vehicles may, for example, be driverless shuttles for passenger transportation or AVP vehicles for driverless parking. AVP vehicles are intended to drive in parking garages or on parking facilities, which are also permitted for mixed traffic with manually driven vehicles. As a result, persons in particular, may also be at risk during the entire AVP maneuver. One particular critical situation may result if, for example, a mother unloads her two children from her vehicle and initially places the first child between her own vehicle and an AVP vehicle parked alongside, in order to then unload the second child on the other side. At exactly this moment, the AVP vehicle may receive the prompt to begin to move again because the driver wants to retrieve his/her vehicle.

To safely recognize persons or objects in the immediate vehicle surroundings with the aid of imaging sensors, for example, close-up range cameras, before beginning to move again in driverless, automatic fashion, a combination of multiple recognition algorithms according to the present invention is provided.

According to one first aspect of the present invention, a method is provided for securing a starting movement of a semi-automated or fully automated vehicle, the vehicle including at least one imaging sensor, which is configured to capture images of a close-up range of the vehicle. The imaging sensor may, for example, include a near-field camera. The vehicle preferably includes a plurality of imaging sensors, for example, cameras at the side mirrors and/or a front camera and/or a rear view camera. Alternatively or in addition, the vehicle may include a camera system for generating a so-called bird's-eye view.

According to an example embodiment of the present invention, a recognition of objects in the close-up range of the vehicle is carried out by carrying out a combination of at least two of the following steps:
a) Capturing an instantaneous image of a close-up range of the vehicle with the aid of the imaging sensor and recognizing objects located in the close-up range of the vehicle by comparing the instantaneous image with a previously stored comparison image, an in particular at risk object in the close-up range being deduced if the comparison indicates that a structure of the comparison image is not completely visible, but is covered in parts by an object. In this case, the previously stored comparison image may preferably have been generated and stored after completion of the previously carried out parking operation of the vehicle or already in the new condition of the vehicle.
b) Alternatively or in addition, a temporally successive capture of at least two instantaneous images takes place with the aid of the imaging sensor and recognition of moving objects in the close-up range of the vehicle by comparing the sequentially captured images using a differential method of digital image processing, in particular, by evaluating the optical flow.
c) Alternatively or in addition, the imaging sensor is designed to be adjustable between two spatial positions at the vehicle, for example, the imaging sensor may be situated at an automatically unfolding or extendable side mirror of the vehicle. As an alternative or additional step for recognizing objects in a close-up range of the vehicle, the imaging sensor is adjusted between at least two positions when the vehicle is at a standstill, for example, in that the initially collapsed side mirror is extended, and at least one image is captured at each of the positions. By comparing the images thus captured at the various positions of the imaging sensor with the aid of a differential method or preferably with the aid of the Structure-from-motion analysis (SfM), it is possible to recognize an object in the close-up range of the vehicle.

A starting movement of the vehicle is prevented if an object has been recognized in at least one of the steps carried out.

The close-up range of the vehicle in this case is understood to mean the area around the vehicle, in particular, a range of 0 meters, which corresponds to a contacting of the vehicle by the object up to approximately 1 meter around the vehicle contour.

It is particularly advantageous if all steps a), b), and c) are carried out. Steps a), b), and/or c) may be carried out in arbitrary order and/or may take place at least partially simultaneously.

The recognition of an object according to step a) takes place in one possible implementation of the present invention in that the structure of the comparison image encompasses a vehicle contour or a vehicle silhouette and an object is recognized if the vehicle contour in the instantaneous image is not completely visible, but is covered in parts by an object.

Thus, it is advantageously possible to reliably recognize objects situated directly at the vehicle, i.e., for example, leaning on one side of the vehicle, in particular, objects in the area of one side of the vehicle between the two fenders. Objects in the area of the front or of the rear of the vehicle may be recognized if the object protrudes beyond the bumper.

Alternatively or in addition, the structure of the comparison image may encompass a ground structure. An object is recognized if the ground structure in the instantaneous image is not completely visible, but is covered in parts by an object. In this case, image contents of the instantaneous image and of the previously stored comparison image are preferably compared and areas are detected, which have changed. From this, a two-dimensional size estimation and relevance assessment for a recognized object may be derived. By this means, it is also possible to recognize objects having a certain distance to the vehicle.

Alternatively or in addition to step a), step b) is carried out in order to detect moving objects. This takes place by comparing at least two temporally successively captured images and evaluating the optical flow or other differential methods.

In this way, it is possible to detect moving objects in the field of view of the imaging sensor. In this way, objects are also detected, which are stationary on the whole, but on which parts are moving, for example, a waving person. If the object as a whole moves, a motion direction of the object may be deduced therefrom by evaluating the optical flow. If necessary, the size may also be deduced by triangulation or via the disparity.

The object recognition carried out according to step a) may be error prone in some cases if, for example, the lighting conditions between the recording point in time of the comparison image and the recording point in time of the instantaneous image have changed or strong light reflections occur.

The object recognition carried out according to step b) presupposes that at least parts of the object are moving. This is not always the case.

In order to compensate for these disadvantages and/or to further enhance the reliability of the object recognition, an object recognition may alternatively or additionally be carried out according to step c).

In this step, a three-dimensional detection of objects in the close-up range of the vehicle takes place by changing the spatial position of the imaging sensor and capturing at least two images each at a different spatial position of the imaging sensor when the vehicle is otherwise at a standstill, and recognizing stationary objects in the close-up range of the vehicle by comparing the images captured at the different positions of the imaging sensor. This may be implemented, for example, by a pan shot of a camera situated at a pivotable or unfolding side mirror of the vehicle. Other holders, which enable a motion of the camera when the vehicle is otherwise at a standstill, are also possible, for example, a moveable holder for the imaging sensor. An arrangement of the imaging sensor at a pivotable or a folding or unfolding side mirror, in particular, yields the advantages that objects in the side area of the vehicle are able to be detected three-dimensionally in the overlapping area of the two images without the need for an additional holder for the imaging sensor. An object size and object position relative to the vehicle may also be determined and as a result of which, a specific collision relevance may be indicated. In this case, the best possible results may be achieved if a position of an imaging sensor is changed between at least two spatial positions on the vehicle in such a way that, on the one hand, a larger detection area (field of view) is covered and, on the other hand, a greater overlap of the detection area at the various positions is ensured.

Steps a), b), and c) may be carried out individually or in combination depending on the situation or need. Thus, it may be provided that initially only one object recognition is carried out according to steps a) and/or b). If no object is recognized in the process, another object recognition is carried out according to step c). Any other combination is also possible and is subject matter of the present invention.

By combining steps a), b), and c), it is advantageously possible to recognize with a high degree of reliability an object in the close-up range of the vehicle such as, for example, a child or an opened vehicle door of an adjacent vehicle.

If no object has been recognized in any of steps a), b), or c), a slow starting movement of the vehicle is preferably initiated, in particular, at an acceleration of less than 0.1 m/s². The starting movement may take place forward or backward, in the direction of an imminent unparking process or opposite the direction of the imminent unparking process. Further images of the close-up range of the vehicle may be captured during the slow starting movement with the aid of the imaging sensor. A recognition of non-moving objects in the close-up range of the vehicle then preferably takes place by a structure-from-motion analysis of image changes in the images captured during the slow starting movement of the vehicle. In this case, it is sufficient if the vehicle is moved approximately 5 cm and the risk of a collision may thus be minimized.

A further travel of the vehicle is preferably stopped immediately if in this way an object has been recognized in a close-up range of the vehicle.

The risk of a collision with an object during the slow starting movement may be further reduced in one further preferred embodiment of the present invention by moving the vehicle initially slowly a few centimeters in the direction opposite a regular unparking direction and subsequently slowly in the unparking direction. The regular unparking direction refers to the driving direction, in which a regular unparking process of the vehicle takes place. The unparking direction may be forward or backward. In this way, a greater spatial distance between the images to be compared may be achieved, which may improve the quality of the SfM evaluation.

In total, only a difference of approximately 5 cm to 10 cm between the camera positions or vehicle positions is preferably necessary, at which the various images for an SfM evaluation are recorded in order to achieve a sufficient accuracy. During a starting movement, which initially takes place in the direction opposite a regular unparking direction, this means only 2.5 cm to 5 cm having to be driven in each direction, which further significantly reduces the risk of collision with an object in the close-up range of the vehicle.

According to one second aspect of the present invention, a device is provided, which is configured to carry out all steps of the method according to the first aspect. In accordance with an example embodiment of the present invention, the device includes at least one imaging sensor, in particular, a camera, an evaluation unit and a memory unit. The evaluation unit is designed to evaluate images that are captured by the imaging sensor of a close-up range of the vehicle and, based on the evaluation, to recognize objects in a close-up range of the vehicle, the evaluation unit being configured to recognize objects located in the close-up range of the vehicle by comparing an instantaneous image with a comparison image previously stored and present in the memory unit, an at risk object in the close-up range being deduced if the comparison indicates that a structure of the comparison image is not completely visible, but is covered in parts by an object; and/or the evaluation unit is configured to recognize moving objects located in the close-up range of the vehicle by comparing at least two temporally successively captured images by evaluating the optical flow; and/or that the imaging sensor is mountable on a vehicle in such a way that the imaging sensor is adjustable between at least two spatial positions, and the evaluation unit also being designed, for recognizing objects in a close-up range of the vehicle, to compare images that have been captured at the various spatial positions and, based on the comparison, to recognize an object in the close-up range of the vehicle. The evaluation unit is configured to output a signal, as a result of which a starting movement of the vehicle is prevented if an object has been recognized by the evaluation unit.

According to one third aspect of the present invention, a motor vehicle is provided, which includes the device according to the second aspect.

According to one fourth aspect of the present invention, a computer program is provided, which includes commands which, when the computer program is executed by a computer, for example, by the device according to the second aspect, prompts the computer to carry out a method according to the first aspect.

According to one fifth aspect of the present invention, a machine-readable memory medium is provided, on which the computer program according to the fourth aspect is stored.

The present invention is based on and includes the finding that the above object may be achieved in that various methods for the image-based recognition of objects from images that have been captured by an imaging sensor at the vehicle may be efficiently combined in order to reliably recognize objects in a close-up range of the vehicle. In this case, it is not necessary to focus on an object recognition and classification on the basis of a single image, instead, comparative methods are used, which are less computationally intensive and with the aid of which both moving as well as stationary objects may be reliably recognized. Multiple fallback levels are formed, which ensure a recognition of an at risk object, even in the case of, for example, difficult lighting conditions or altered weather conditions. Thus, the safety of persons in the surroundings of vehicles operating in an automated or autonomous manner may be advantageously ensured.

Only when it has been determined on the basis of the surroundings detection of the imaging sensor or sensors of the vehicle that no object is located in the close-up range of the vehicle, which could be put at risk by a driving off of the vehicle and/or which could put the vehicle at risk by a driving off of the vehicle, is an approval issued for a travel of a vehicle guided in an at least semi-automated manner, otherwise the starting movement is prevented.

This yields, in particular, the technical advantage that an endangerment of objects located in a close-up range of the vehicle may be reduced or eliminated.

This further yields the technical advantage that the vehicle is not damaged by a corresponding object.

Given the above, this yields, in particular, the advantage that a concept is provided for efficiently securing a vehicle starting movement guided in an at least semi-automated manner.

In addition, objects in the captured images, preferably on the images captured by the imaging sensor, may be recognized and classified based on their shape with the aid of methods of digital image processing. In this way, a further plausibility check of the results obtained according to steps a), b), and/or c) may advantageously take place and the safety and reliability of the method may be further enhanced.

It is further preferably possible to determine with the aid of at least one distance sensor situated at the vehicle one or multiple distances between the vehicle and objects in the surrounding of the vehicle. Objects in the close-up range of the vehicle may thereby also be detected. A distance measurement may take place, for example, if an object has been recognized according to at least one of steps a., b., or c. By determining the distance of the object to the vehicle, it is possible to obtain more exact pieces of information about the object. A distance measurement may also be carried out regardless of the result of steps a., b., or c. The distance sensor used may, for example, be an ultrasonic sensor, a radar sensor or a LIDAR sensor. Distance sensors may preferably be situated at the vehicle where the detection range or ranges of the imaging sensor or sensors of the vehicle include(s) gaps or no overlap. Thus, the starting movement of the vehicle may also be prevented or aborted if an object is detected by at least one of the distance sensors in a close-up range of the vehicle. This may further enhance the safety.

### BRIEF DESCRIPTION OF THE DRAWINGS

An exemplary embodiment of the present invention is represented in the figures and explained in greater detail below.

FIGS. 1a) and 1b) schematically represent an automatic valet parking (AVP) process, the situation during the drop-off of the vehicle being represented in FIG. 1a) and the pick-up process being represented in FIG. 1b).

FIGS. 2a)-2b) show a vehicle according to one possible example embodiment of the present invention. FIG. 2a) shows a side view of the vehicle, FIG. 2b) shows a top view of the vehicle.

FIGS. 3a), 3b), and 3c) each show a fold-out side mirror including a camera of a vehicle designed according to one embodiment of the present invention in three different positions.

FIGS. 4a) and 4b) show an object recognition during a slow starting movement of a vehicle according to one preferred embodiment of the present invention.

FIG. 5 schematically shows a device according to one exemplary embodiment of the present invention.

FIG. 6 shows a flowchart of a method according to one possible embodiment of the present invention.

The figures represent only schematically the subject matter of the present invention.

### DETAILED DESCRIPTION OF EXAMPLE EMBODIMENTS

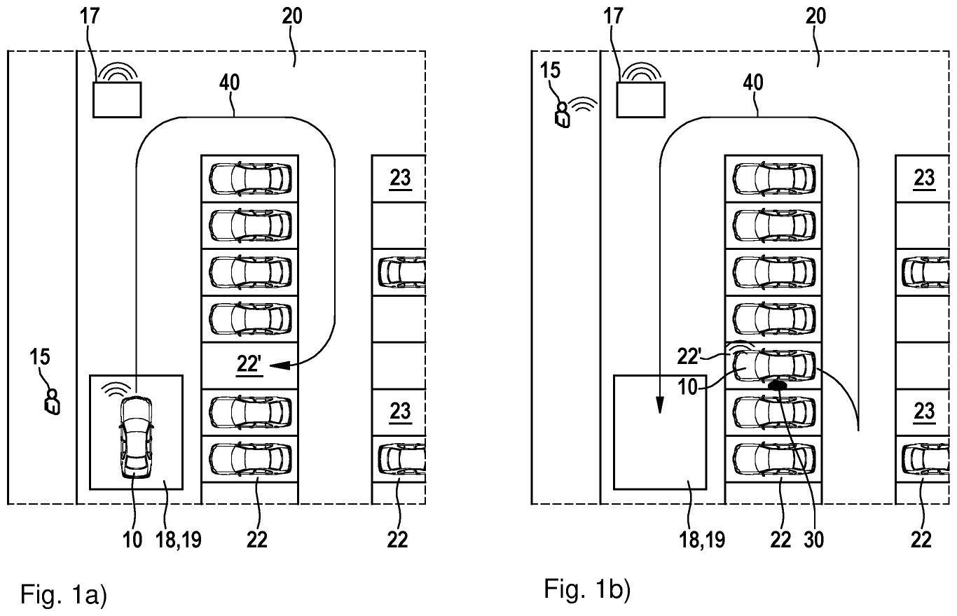

FIGS. 1a) and 1b) schematically show one example of an application of the method according to the present invention for a parking surroundings 20 of an AVP system, in this example, an AVP system being depicted, in which the control unit of the AVP trip is located in the parking surroundings. The following description is based on this system distribution with the control unit in the parking surroundings. Parking surroundings 20 are constituted here as a parking deck of a parking garage. Parking surroundings 20 include a multitude of parking spaces 22, 23, a central unit 17 and a multitude of stationary sensor units (not shown). Central unit 17 includes a computing device and a communication unit, neither of which is shown separately for the sake of clarity. In one further exemplary embodiment of an AVP system, the control unit for the AVP trip may be located in the vehicle itself.

Parking surroundings 20 are configured to guide a vehicle 10 starting from a drop-off area 18 to one of parking spaces 22′ and to park it there. If vehicle 10 is needed again, it is guided by parking surroundings 20 to a pick-up area 19, which in this example, is identical to drop-off area 18. In the process, a driver 15 of vehicle 10 leaves vehicle 10 after parking in drop-off area 18 and later receives it again in pick-up area 19.

For an automatic trip within parking surroundings 20, vehicle 10 includes a control unit, which activates corresponding actuators for the longitudinal guidance and transverse guidance of vehicle 10. The control unit in this case follows a trajectory 40 provided to it by parking surroundings 20. For example, this trajectory 40 is conveyed to vehicle 10 with the aid of a communication unit of central unit 17.

The present invention is applicable, in particular, when vehicle 10, as shown in FIG. 1b) receives the command to leave parking space 22′ and to drive autonomously, i.e., without a person being situated in vehicle 10, to pick-up area 19. It is possible that in the interim an at risk object 30 has appeared, in particular, in the areas between vehicle 10 and the adjacent vehicles. Vehicle 10 therefore includes at least one camera, preferably, however, multiple cameras.

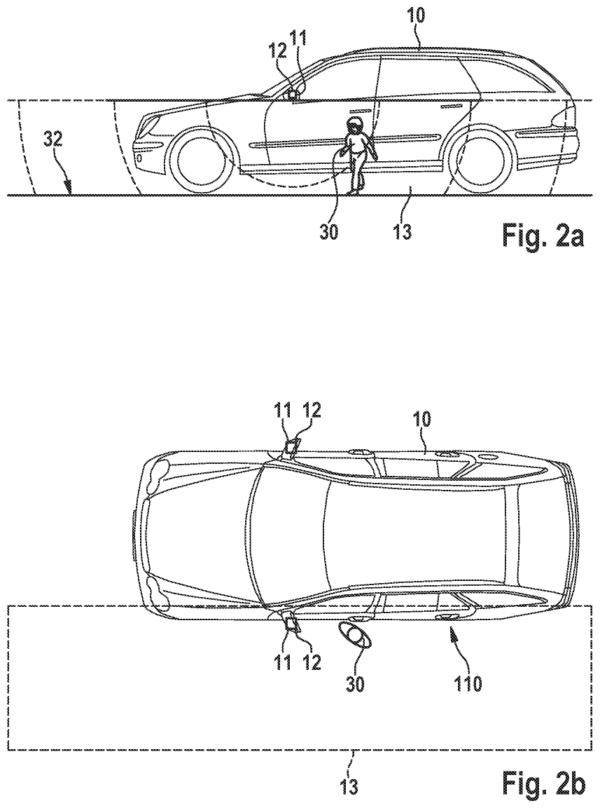

One exemplary embodiment of a vehicle 10 is represented in FIGS. 2a) and 2b). In this case, FIG. 2a) shows a side view of vehicle 10 and FIG. 2b) shows a top view from above. Vehicle 10 includes a camera 12 at each of its side mirrors 11. The field of view or the detection area of left-side camera 12 is schematically represented by area 13 and encompasses a close-up range of vehicle 10 on its left side. The right-side field of view is similarly formed and not otherwise shown. The field of view of camera 12 encompasses the respective side of vehicle 10, in particular, vehicle contour 110 on the respective side, as well as roadway 32 on the respective side.

An at risk object 30, in this example, a child, is located at the left side of vehicle 10 in the area between the doors.

Camera 12 now captures an instantaneous image of the side area of vehicle 10. The captured instantaneous image is compared with a previously stored comparison image. If the comparison indicates that a structure of the comparison image is not completely visible, but is covered in parts by an object, an at risk object 30 in the detection area 13 of camera 12 is deduced. For this purpose, it may be checked, for example, whether vehicle contour 110 is interrupted or concealed as compared to the comparison image. If a concealment or interruption of vehicle contour 110 is recognized in the instantaneous image, an object 30 is deduced.

The recognition of an object 30 by checking vehicle contour 110 may fail, however, if object 30 exhibits a distance to vehicle 10 so that vehicle contour 110 is not concealed or interrupted, or if object 30 is located, for example, in the area of the front or rear fender of vehicle 10. A ground structure of the comparison image may therefore alternatively or in addition be compared with the instantaneous image and an object may be recognized if the ground structure in the instantaneous image is not completely visible, but is covered at least in parts by object 30.

The described recognition of an object 30 by comparing an image captured instantaneously with the aid of camera 12 with a previously stored comparison image may encounter problems if the lighting conditions between the recording of the instantaneous image and the comparison image differ drastically, or if, for example, light reflections or strong shadow casting occurs. In these cases, objects may be recognized even though in reality no object 30 is present (false positive).

In order to also detect moving objects and to recognize them as such, at least two images may additionally or alternatively be captured temporally in quick succession by camera 12. A moving object in the close-up range of vehicle 10 or in detection area 13 of camera 12 may then be detected by comparing the temporally successively captured images by evaluating with the aid of a differential method or preferably with the aid of optical flow. If an optical flow is established, an at least partially movable object 30 may then be deduced. Problems in the image comparison as a result of changing lighting conditions present no greater problem in this evaluation, since the images to be compared are recorded preferably at a short temporal interval (typically approximately 1 s).

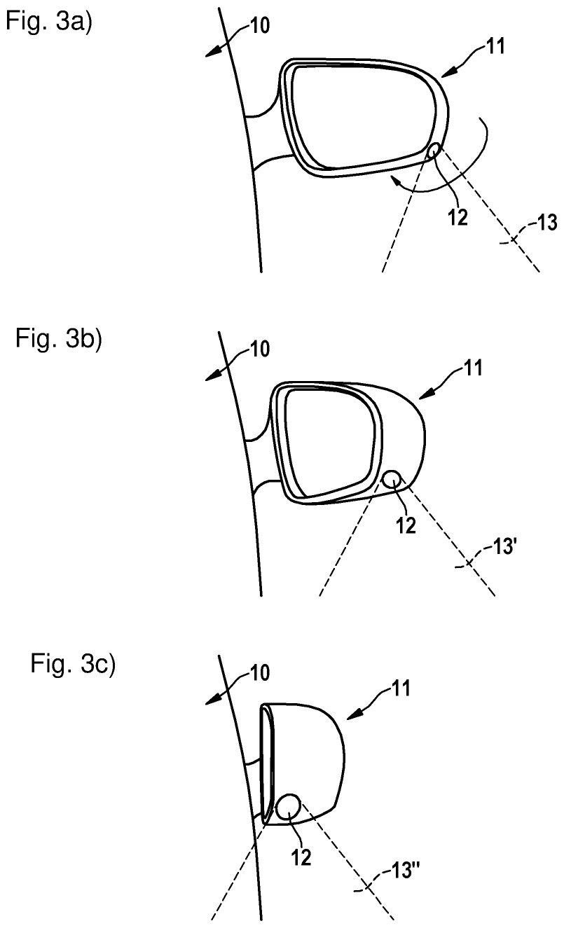

In order to further improve the object recognition, a change of the spatial position of cameras 12 and capture of at least two images at respectively different spatial positions of a camera 12 may then alternatively or additionally be carried out. The size and position of objects 30 in the close-up range of vehicle 10 is determined by an SfM analysis of the images captured at the different positions of the imaging sensor. The change of the spatial position of camera 12 takes place when vehicle 10 is otherwise at a standstill, for example, by moving side mirror 11, at which camera 12 is situated, automatically into another position, for example, unfolded or folded. One possible embodiment is represented in greater detail in FIG. 3.

A top view of a detail of a vehicle 10 is represented in FIG. 3a) in the area of a side mirror 11 in a first position of the side mirror. Side mirror 11 is provided in its operating position for observing a rearward area located next to and behind vehicle 10. A camera 12 is situated in or directly at side mirror 11, which is provided, for example, for capturing images for producing a representation of vehicle 10 and of its surroundings. For this purpose, camera 12 has a detection area 13 in the operating position of side mirror 11, which covers a surroundings area extending directly next to vehicle 10 and in the longitudinal direction of vehicle 10 in front of and behind side mirror 11.

Side mirror 11 is automatically foldable from the operating position shown in FIG. 3a) into the second and third positions in the direction of a vehicle body shown in greater detail in FIGS. 3b) and 3c).

Camera 12 in the exemplary embodiment shown is situated at a side of side mirror 11 facing away from the vehicle body, in particular, at a transition from an underside of the same to a side surface facing away from the vehicle body. In this case, camera 12 in the completely or partially folded rest positions of side mirror 11 according to FIGS. 3b) and 3c) has a detection area 13′ and 13″, which covers a surroundings area extending in the longitudinal direction of vehicle 10 behind side mirror 11, which overlaps at least partially with detection area 13.

At least one image of the vehicle surroundings may then be captured by camera 12 at each of the positions or at least two of the positions according to FIGS. 3a), 3b) and 3c). By comparing the images, it is possible to recognize an object 30 in an overlapping area of the images.

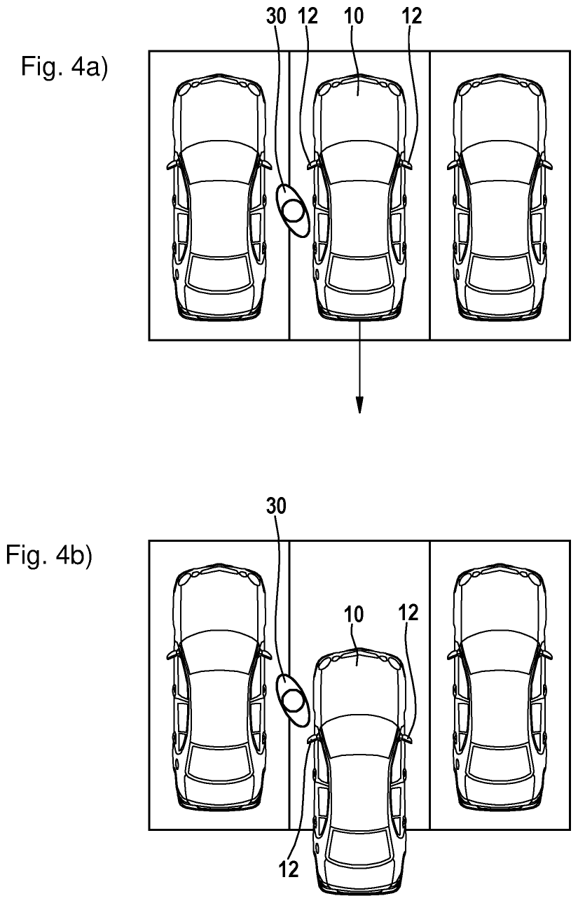

FIG. 4a) shows the situation in which vehicle 10 has received the prompt to start up and no object 30 has been recognized in the close-up range of vehicle 10 during the implementation of a) through c). In one preferred embodiment of the present invention, vehicle 10 may now, as indicated in FIG. 4b), commence a starting movement at a very slow speed. During this slow starting movement, images of the close-up range of vehicle 10 continue to be captured with cameras 12. Object 30 may now be recognized by a structure-from-motion analysis of image changes of the images captured during the slow starting movement of vehicle 10, a further travel of vehicle 10 being stopped once object 30 has been recognized. The vehicle may, in particular, initially drive in the direction opposite the regular unparking direction, in this example, forward, and subsequently drive in the unparking direction, in this example, backward. In the process, vehicle 10 accelerates preferably at less than 0.1 m/s² and drives a distance of approximately 5 cm to 10 cm in the respective direction. In the process, at least one first image may be captured during the forward travel, for example. A second image may, for example, be captured when the vehicle has already traveled a particular distance backward during the subsequent backward travel, so that a preferably large spatial distance exists between the positions at which the images are captured. This improves the accuracy of a structure-from-motion analysis.

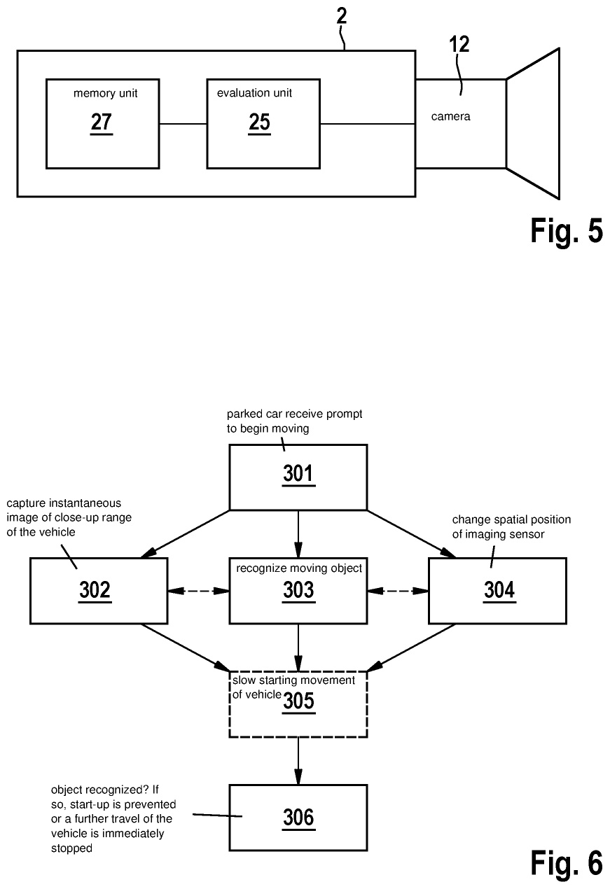

FIG. 5 schematically shows a device 2 according to one exemplary embodiment of the present invention. The device includes at least one imaging sensor, in this example, a camera 12, an evaluation unit 25 and a memory unit 27. Evaluation unit 25 is designed to evaluate images captured by camera 12 of a close-up range of vehicle 10 and, based on the evaluation, to recognize objects 30 in a close-up range of vehicle 10, the evaluation unit being configured to recognize objects 30 located in the close-up range of vehicle 10 by comparing an instantaneous image with a comparison image previously stored and present in memory unit 27, an at risk object 30 in the close-up range being deduced if the comparison indicates that a structure of the comparison image is not completely visible, but is covered in parts by an object 30.

Evaluation unit 25 is further configured to recognize moving objects 30 located in the close-up range of vehicle 10 by comparing at least two temporally successively captured images, by evaluating the optical flow or by applying other differential methods.

Camera 12 is mountable at a vehicle 10 in such a way that the camera is adjustable between at least two spatial positions, for example, as shown in FIG. 3, by mounting camera 12 in a movable side mirror 11 of vehicle 10. Evaluation unit 25 is also designed, for recognizing objects in a close-up range of the vehicle, to compare images that have been captured at the various spatial positions of camera 12 and, based on the comparison, to recognize an object 30 in the close-up range of the vehicle.

Evaluation unit 25 is configured to output a signal, which may be further processed, for example, by a control unit of vehicle 10, as a result of which a starting movement is prevented if an object 30 has been recognized by evaluation unit 25.

The sequence of a method carried out according to one exemplary embodiment of the present invention is represented in FIG. 6. In step 301, a parked vehicle receives the prompt to begin moving. The recognition of objects in a close-up range of the vehicle is subsequently started. For this purpose, an instantaneous image of the close-up range of the vehicle is captured in step 302 with the aid of an imaging sensor of the vehicle. An object in the close-up range of the vehicle is recognized by comparing the captured instantaneous image with a previously stored comparison image, an in particular at risk object in the close-up range being deduced if the comparison indicates that a structure of the comparison image is not completely visible, but is covered in parts by an object. In addition or alternatively, a moving object is recognized in step 303 by the imaging sensor capturing temporally successively at least two images of the close-up range of the vehicle. A moving object in the close-up range of the vehicle is recognized by comparing the temporally successively captured images and by evaluating the optical flow. In addition or alternatively, a spatial position of the imaging sensor relative to the vehicle otherwise at a standstill is changed in step 304, and at least two images are captured at respectively different positions of the imaging sensor. A stationary object in the close-up range of the vehicle is recognized by comparing the images captured at the different positions of the imaging sensors.

If no object has been recognized in steps 302, 303 and 304, step 305 may optionally be carried out. In this step, a slow starting movement of the vehicle takes place, in particular, at an acceleration of less than 0.1 m/s², images of the close-up range of the vehicle being captured with the aid of the imaging sensor. A recognition of non-moving objects in the close-up range of the vehicle takes place by a structure-from-motion analysis of image changes of the images captured during the slow starting movement of the vehicle.

In step 306, it is queried whether an object has been recognized in one of the previous steps. If an object has been recognized, the starting movement of the vehicle is prevented or a further travel of the vehicle is immediately stopped.

The present invention is not restricted to the exemplary embodiments described herein and to the aspects highlighted therein. Instead, a multitude of modifications is possible within the scope of the present invention, which fall within the practice routine to those skilled in the art in view of the disclosure herein.

1-14. (canceled)

15. A method for securing a starting movement of a semi-automated or fully automated vehicle, the vehicle including at least one imaging sensor, the imaging sensor including a near-field camera which is configured to capture images of a close-up range of the vehicle, the method comprising the following steps:
carrying out a recognition of objects in the close-up range of the vehicle prior to a starting movement of the vehicle when the vehicle is stationary by carrying out a combination of at least two of the following steps:
a) capturing an instantaneous image of the close-up range of the vehicle using the imaging sensor and recognizing objects located in the close-up range of the vehicle by comparing the instantaneous image with a previously stored comparison image, an at risk object in the close-up range being deduced when the comparison indicates that a structure of the comparison image is not completely visible, but is covered in parts by an object, and/or
b) temporally successively capturing at least two instantaneous images using the imaging sensor and recognizing moving objects in the close-up range of the vehicle by comparing the temporally successively captured images and evaluating optical flow or another differential method, and/or
c) changing a spatial position of the imaging sensor and capturing at least two images at respectively different spatial positions of the imaging sensor and recognizing objects in the close-up range of the vehicle by analyzing changes, by using a structure-from-motion analysis, of the images captured at the different positions of the imaging sensor; and
preventing the starting movement of the vehicle when at least one object has been recognized.

16. The method as recited in claim 15, wherein, if no object has been recognized by the steps a) and/or b) and/or c) when vehicle is stationary, a slow starting movement of the vehicle takes place, images of the close-up range of the vehicle being captured using the imaging sensor and recognizing objects in the close-up range of the vehicle by an analysis, by a structure-from-motion analysis, of image changes of the images captured during the slow starting movement of the vehicle, a further travel of the vehicle being stopped when an object has been recognized.

17. The method as recited in claim 16, wherein the vehicle initially drives in a direction opposite an unparking direction and subsequently drives slowly in the unparking direction, the unparking direction being a driving direction in which a regular unparking process of the vehicle takes place.

18. The method as recited in claim 15, wherein the structure of the comparison image includes a vehicle contour and an object is recognized when the vehicle contour is not completely visible in the instantaneous image, but is covered in parts by an object.

19. The method as recited in claim 15, wherein the structure of the comparison image includes a ground structure, and an object is recognized when the ground structure is not completely visible in the instantaneous image, but is covered in parts by an object.

20. The method as recited in claim 15, wherein objects are additionally recognized in the images captured by the imaging sensor using methods of digital image processing, and are classified based on their shape.

21. The method as recited in claim 15, wherein one or multiple distances between the vehicle and objects in the surroundings of the vehicle is also determined using at least one distance sensor situated at the vehicle, which is configured as an ultrasonic sensor and/or a radar sensor and/or a LIDAR sensor.

22. A device configured to secure a starting movement of a semi-automated or fully automated vehicle, comprising:
at least one imaging sensor including a camera;
an evaluation unit; and
a memory unit;
wherein the evaluation unit is configured to evaluate images captured by the imaging sensor of a close-up range of a vehicle and, based on the evaluation, to recognize objects in the close-up range of the vehicle, and:
a) the evaluation unit is configured to recognize objects located in the close-up range of the vehicle by comparing an instantaneous image with a comparison image previously stored and present in the memory unit, an object in the close-up range being deduced when the comparison indicates that a structure of the comparison image is not completely visible, but is covered at least in parts by an object; and/or
b) the evaluation unit is configured recognize moving objects located in the close-up range of the vehicle by comparing at least two temporally successively captured images by evaluating optical flow; and/or
c) the imaging sensor is mountable at the vehicle in such a way that the imaging sensor is adjustable between at least two spatial positions, and the evaluation unit is configured to recognize objects in the close-up range of the vehicle, to compare images captured at different spatial positions and, based on the comparison, to recognize an object in the close-up range of the vehicle;
wherein the evaluation unit is configured to output a signal, as a result of which the starting movement of the vehicle is prevented when an object has been recognized by the evaluation unit.

23. The device as recited in claim 22, wherein the evaluation unit is configured to, if no object has been recognized by the steps a) and/or b) and/or c) when the vehicle is stationary, to output a signal for a slow starting movement of the vehicle, and to recognize during the slow starting movement objects in the close-up range of the vehicle by a structure-from-motion analysis of image changes of images captured during the slow starting movement of the vehicle, the evaluation unit being configured to output a signal, as a result of which a further travel of the vehicle is stopped when an object has been recognized by the evaluation unit.

24. The device as recited in claim 22, wherein the imaging sensor is mounted at a folding exterior mirror of a vehicle.

25. The device as recited in claim 22, wherein the device further includes at least one distance sensor, the at least one distance sensor being an ultrasonic sensor and/or a radar sensor and/or a LIDAR sensor.

26. A vehicle configured for a semi-automated or fully automated operation, the vehicle comprising:
a device configured to secure a starting movement of a semi-automated or fully automated vehicle, including:
at least one imaging sensor including a camera;
an evaluation unit; and
a memory unit;
wherein the evaluation unit is configured to evaluate images captured by the imaging sensor of a close-up range of the vehicle and, based on the evaluation, to recognize objects in the close-up range of the vehicle, and:
a) the evaluation unit is configured to recognize objects located in the close-up range of the vehicle by comparing an instantaneous image with a comparison image previously stored and present in the memory unit, an object in the close-up range being deduced when the comparison indicates that a structure of the comparison image is not completely visible, but is covered at least in parts by an object; and/or
b) the evaluation unit is configured recognize moving objects located in the close-up range of the vehicle by comparing at least two temporally successively captured images by evaluating optical flow; and/or
c) the imaging sensor is mountable at the vehicle in such a way that the imaging sensor is adjustable between at least two spatial positions, and the evaluation unit is configured to recognize objects in the close-up range of the vehicle, to compare images captured at different spatial positions and, based on the comparison, to recognize an object in the close-up range of the vehicle;
wherein the evaluation unit is configured to output a signal, as a result of which the starting movement of the vehicle is prevented when an object has been recognized by the evaluation unit.

27. A non-transitory machine-readable memory medium on which is stored a computer program for securing a starting movement of a semi-automated or fully automated vehicle, the vehicle including at least one imaging sensor, the imaging sensor including a near-field camera which is configured to capture images of a close-up range of the vehicle, the computer program, when executed by a computer, causing the computer to perform the following steps:
carrying out a recognition of objects in the close-up range of the vehicle prior to a starting movement of the vehicle when the vehicle is stationary by carrying out a combination of at least two of the following steps:
a) capturing an instantaneous image of the close-up range of the vehicle using the imaging sensor and recognizing objects located in the close-up range of the vehicle by comparing the instantaneous image with a previously stored comparison image, an at risk object in the close-up range being deduced when the comparison indicates that a structure of the comparison image is not completely visible, but is covered in parts by an object, and/or
b) temporally successively capturing at least two instantaneous images using the imaging sensor and recognizing moving objects in the close-up range of the vehicle by comparing the temporally successively captured images and evaluating optical flow or another differential method, and/or
c) changing a spatial position of the imaging sensor and capturing at least two images at respectively different spatial positions of the imaging sensor and recognizing objects in the close-up range of the vehicle by analyzing changes, by using a structure-from-motion analysis, of the images captured at the different positions of the imaging sensor; and
preventing the starting movement of the vehicle when at least one object has been recognized.
